(19) United States
(12) Patent Application Publication
(10) Pub. No.: US 2026/0135130 A1
(43) Pub. Date: May 14, 2026

(54) FUEL CELL SYSTEM INCLUDING SILICON SPECIES TRAPPING MATERIAL OR SILICON SPECIES TOLERANT CATALYST AND METHOD OF OPERATING THEREOF

(71) Applicant: BLOOM ENERGY CORPORATION, San Jose, CA (US)

(72) Inventors: Chithra ASOKAN, Oakland, CA (US); Mohammad KHAN, Mumbai (IN); Srikanth RANGANATHAN, San Jose, CA (US); Shraddesh MALVIYA, Mumbai (IN)

(21) Appl. No.: 18/976,671

(22) Filed: Dec. 11, 2024

Related U.S. Application Data
(60) Provisional application No. 63/613,361, filed on Dec. 21, 2023.

(51) Int. Cl. H01M 8/04791; H01M 4/90; H01M 8/04701; H01M 8/2432

(52) U.S. Cl. CPC H01M 8/04805; H01M 4/9033; H01M 4/9058; H01M 8/04708; H01M 8/04716; H01M 8/2432

(57) ABSTRACT

A fuel cell system includes a stack of fuel cells, a fuel supply line configured to provide a fuel to the stack, an anode exhaust line configured to receive an anode exhaust from the stack, and a trapping component configured to sequester silicon species included in the anode exhaust.

### FIELD

Aspects of the present disclosure relate to fuel cell systems, and more particularly, to fuel cell systems including silicon species trapping material or silicon species tolerant catalyst.

### BACKGROUND

Fuel cells, such as solid oxide fuel cells, are electrochemical devices which can convert energy stored in fuels to electrical energy with high efficiency. High temperature fuel cells include solid oxide and molten carbonate fuel cells. These fuel cells may operate using hydrogen and/or hydrogen-containing fuels. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, a fuel cell system comprises a stack of fuel cells, a fuel supply line configured to provide a fuel to the stack, an anode exhaust line configured to receive an anode exhaust from the stack, and a trapping component configured to sequester silicon species included in the anode exhaust.

According to various embodiments, a method of operating a fuel cell system comprises providing a fuel to a stack of fuel cells, providing an anode exhaust containing a silicon species from the stack, and sequestering the silicon species at a trapping component.

According to various embodiments, a fuel cell system comprises a stack of fuel cells, an anode recuperator configured to heat a fuel provided to the stack using an anode exhaust output from the stack, and a reformation catalyst located in the anode recuperator, the reformation catalyst comprising nickel and a metal oxide.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1A is a perspective view of a stack of solid oxide fuel cells, according to various embodiments of the present disclosure. FIG. 1B is a sectional view of a portion of the stack of FIG. 1A.

FIG. 2 is a schematic view of a fuel cell system, according to various embodiments of the present disclosure.

FIGS. 3A and 3B are side cross-sectional views showing flow distribution through a central column of the fuel cell system of FIG. 2. FIG. 3C is a perspective view of an anode fuel distribution structure on which the central column may be located.

### DETAILED DESCRIPTION

As set forth herein, various aspects of the disclosure are described with reference to the exemplary embodiments and/or the accompanying drawings in which exemplary embodiments of the invention are illustrated. This invention may, however, be embodied in many different forms and should not be construed as limited to the exemplary embodiments shown in the drawings or described herein. It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, examples include from the one particular value and/or to the other particular value. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

In a high temperature fuel cell system, such as a solid oxide fuel cell (SOFC) system, an oxidizing flow is directed to the cathode side of the fuel cell while a fuel flow is directed to the anode side of the fuel cell. The oxidizing flow is typically air, while the fuel flow can be hydrogen (H₂) or a hydrocarbon fuel, such as methane, natural gas, propane (e.g., liquefied petroleum gas (LPG)), ethanol, or methanol. Alternatively, ammonia may be used as a fuel. The fuel cell, operating at a typical temperature between 700°C. and 950°C., enables the transport of negatively charged oxygen ions from the cathode flow stream to the anode flow stream, where the oxygen ions combine with either free hydrogen or hydrogen in a hydrocarbon or ammonia molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit.

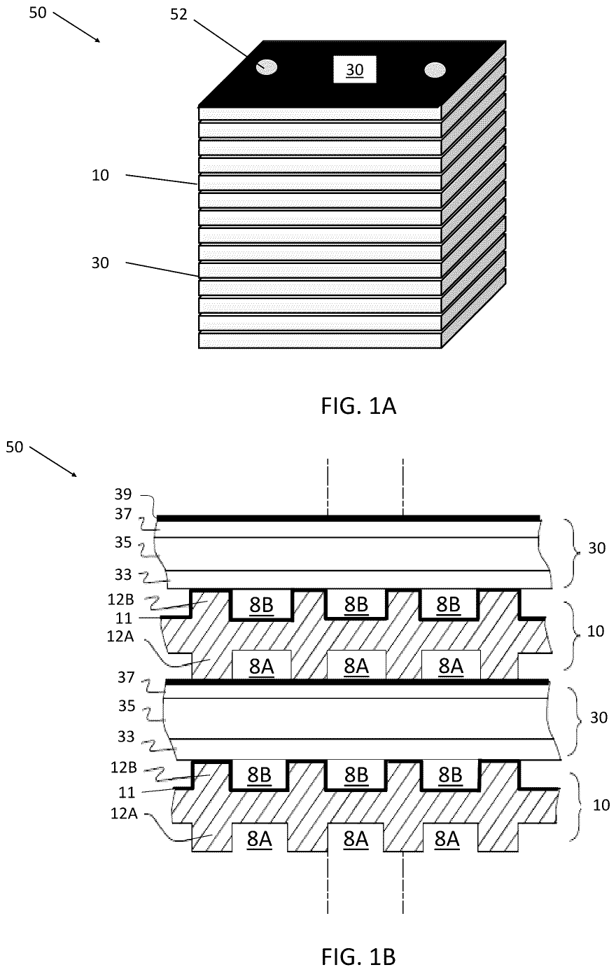

FIG. 1A is a perspective view of a solid oxide fuel cell stack 50, and FIG. 1B is a sectional view of a portion of the stack 50 of FIG. 1A, according to various embodiments of the present disclosure.

In the embodiments below, the stack 50 is described as being operated as a SOFC stack 50 in a power generation mode. However, it should be noted that the stack 50 may also be a reversible fuel cell system which may be operated as an electrolyzer (e.g., a solid oxide electrolyzer cell (SOEC) stack) in electrolysis mode in addition to being operated in the power generation mode.

Referring to FIGS. 1A and 1B, the stack 50 includes fuel cells 30, such as solid oxide fuel cells (e.g., SOFCs) separated by interconnects 10. Referring to FIG. 1B, each fuel cell 30 comprises a cathode electrode 33, a solid oxide electrolyte 35, and an anode electrode 37. In some embodiments, the fuel cells 30 may include a conductive layer, such as a nickel mesh 39, located between the anode electrode 37 and an adjacent interconnect 10.

Various materials may be used for the cathode electrode 33, electrolyte 35, and anode electrode 37. For example, the anode electrode 37 may comprise a cermet comprising a nickel containing phase and a ceramic phase. The nickel containing phase may consist entirely of nickel in a reduced state. This phase may form nickel oxide when it is in an oxidized state. Thus, the anode electrode 37 is preferably annealed in a reducing atmosphere prior to operation to reduce the nickel oxide to nickel. The nickel containing phase may include other metals in addition to nickel and/or nickel alloys. The ceramic phase may comprise a stabilized zirconia, such as yttria and/or scandia stabilized zirconia and/or a doped ceria, such as gadolinia, yttria and/or samaria doped ceria.

The electrolyte 35 may comprise a stabilized zirconia, such as scandia stabilized zirconia (SSZ) or yttria stabilized zirconia (YSZ). Alternatively, the electrolyte 35 may comprise another ionically conductive material, such as a doped ceria.

The cathode electrode 33 may comprise an electrically conductive material, such as an electrically conductive perovskite material, such as lanthanum strontium manganite (LSM). Other conductive perovskites, such as LSCo, etc., or metals, such as Pt, may also be used. The cathode electrode 33 may also contain a ceramic phase similar to the anode electrode 37. The electrodes and the electrolyte may each comprise one or more sublayers of one or more of the above-described materials. In some embodiments, the fuel cell 30 may include an anode current collector 39, such as a nickel mesh, located on the anode electrode 37. The anode current collector 39 may be used to electrically connect the fuel cell 30 to an adjacent interconnect 10.

Cell stacks 50 are frequently built from a multiplicity of SOFC's 30 in the form of planar elements, tubes, or other geometries. Although the stack 50 in FIG. 1A is vertically oriented, fuel cell stacks may be oriented horizontally or in any other direction. Fuel and air may be provided to the electrochemically active surface of the fuel cell, which can be large. For example, fuel may be provided through fuel conduits 52 (FIG. 1) that extend through the stack 50 and that are formed by aligning openings (e.g., holes) formed in the interconnects 10 and fuel cells 30.

Each interconnect 10 electrically connects adjacent fuel cells 30 in the stack 50. In particular, an interconnect 10 may electrically connect the anode electrode 37 of one fuel cell 30 to the cathode electrode 33 of an adjacent fuel cell 30. FIG. 1B shows that the lower fuel cell 30 is located between two interconnects 10. An optional Ni mesh 39 may be used to electrically connect the interconnect 10 to the anode electrode 37 of an adjacent fuel cell 30.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode (i.e., anode 37) of one cell in the stack from oxidant, such as air, flowing to the air electrode (i.e., cathode 33) of an adjacent cell in the stack. The air and fuel may flow in opposite directions, such that the fuel cell stack 50 has a counter-flow configuration. In alternative embodiments, the air and fuel may flow in the same directions, such that the fuel cell stack 50 has a co-flow configuration, or the air and fuel may flow in in perpendicular directions, such that the fuel cell stack 50 has a cross-flow configuration.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may each include a metallic substrate comprising a high-temperature stable metal alloy, such as a chromium-iron alloy, such as 4-6 weight percent iron, optionally 1 or less weight percent yttrium and balance chromium alloy and may electrically connect the anode or fuel-side of one fuel cell 30 to the cathode or air side of an adjacent fuel cell 30. An electrically conductive contact layer 39, such as a nickel layer or mesh, may be provided between anode electrodes 37 and a fuel side of each interconnect 10.

An electrically conductive protective layer 11 may be provided on at least an air side of each interconnect 10. The protective layer 11 may be configured to decrease the growth rate of a chromium oxide surface layer on the interconnect 10 and to suppress evaporation of chromium vapor species which can poison fuel cell cathodes 33. The protective layer 11 may be a perovskite layer such as lanthanum strontium manganite (LSM) and may be formed using a spray coating or dip coating process. Alternatively, other metal oxide coatings, such as a spinel, such as an (Mn, Co)₃O₄ spinel (MCO), can be used instead of or in addition to LSM. Any spinel having the composition Mn₂₋ₓCo₁₊ₓO₄ (0≤x≤1) or written as z(Mn₃O₄)+(1−z)(Co₃O₄), where (⅓≤z≤⅔) or written as (Mn, Co)₃O₄ may be used. In other embodiments, a mixed layer of LSM and MCO, or a stack of LSM and MCO layers may be used as the protective layer 11.

Multiple stacks 50 may be arranged on one another to form a column. The column may be internally or externally manifolded for fuel and/or air. Optional anode splitter plates may be located between adjacent stacks 50 to provide fuel to the cells of each stack 50 as described in U.S. Pat. No. 10,511,047 B2, which is incorporated herein by reference in its entirety.

While a co-flow or counter-flow interconnect 10 is illustrated in FIG. 1B, in alternative embodiments, the interconnect 10 may comprise a crossflow interconnect in which the air and fuel channels extend perpendicular to each other, as described in U.S. Pat. No. 11,355,762 B2, which is incorporated herein by reference in its entirety. For example, such interconnects 10 may include two or more fuel holes per side of the interconnect.

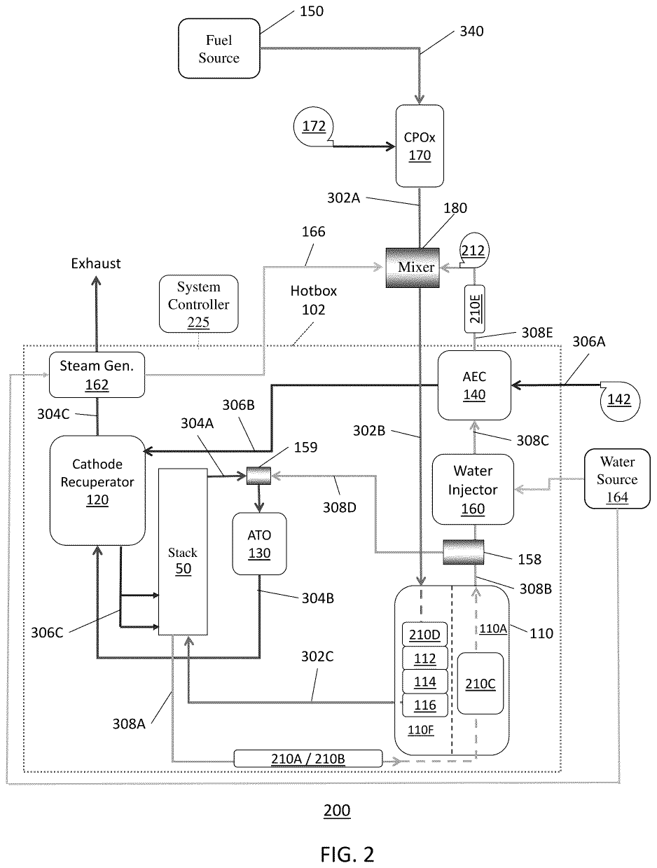

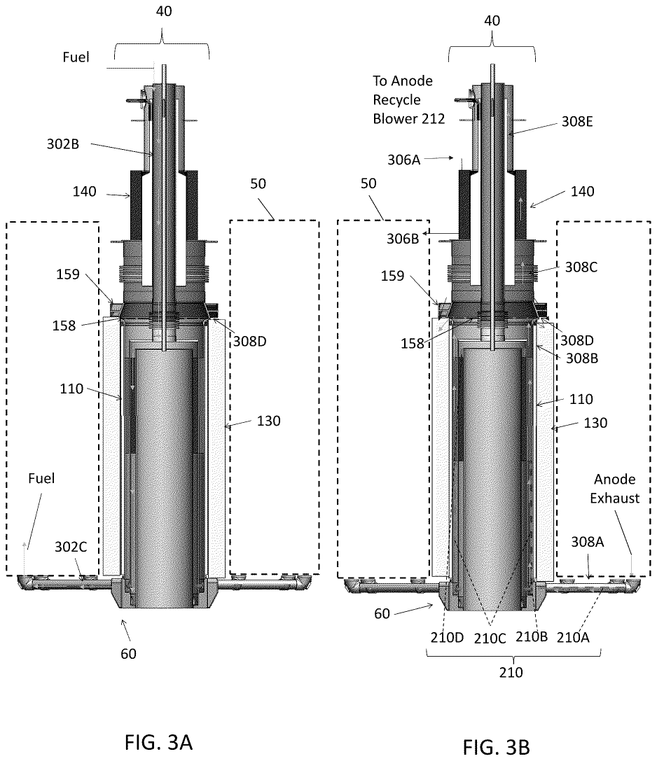

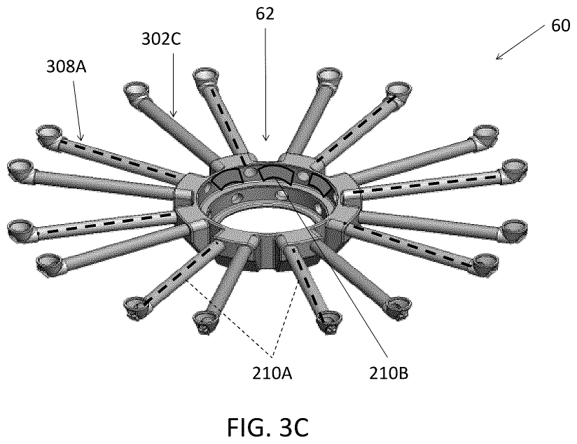

FIG. 2 is a schematic representation of a fuel cell system 200, according to various embodiments of the present disclosure. Referring to FIG. 2, the fuel cell system 200 includes a hotbox 102 and various components located therein or adjacent thereto. The hotbox 102 may contain one or more fuel cell stacks 50, which may be arranged in internally or externally manifolded cell columns as described above. The hotbox 102 may contain multiple columns arranged around a central column (e.g., FIGS. 3A and 3B).

The hotbox 102 may also contain an anode recuperator heat exchanger 110, a cathode recuperator heat exchanger 120, an anode tail gas oxidizer (ATO) 130, an anode exhaust cooler heat exchanger 140, an optional splitter 158, an optional vortex generator 159, and a water injector 160. Alternatively, the water injector 160 may be replaced with a steam generator 162 that provides steam into the fuel inlet stream via the steam conduit 166 and mixer 180. The fuel cell system 200 may also include an optional catalytic partial oxidation (CPOx) reactor 170, an optional CPOx blower (e.g., air blower) 172, the mixer 180, a main air blower 142 (e.g., system blower), and an anode recycle blower 212, which may be located outside of the hotbox 102. However, the present disclosure is not limited to any particular location for each of the components with respect to the hotbox 102.

Water may be provided to the fuel inlet stream from the water source 164 during at least a portion of the start-up operating mode of the fuel cell system 200, for example from the time the stack 50 temperature is 200° C. until the stack reaches it steady-state operating temperature (e.g., a temperature of at least 700° C., such as 750° C. to 900° C. ). During steady-state operating mode, the fuel cell system 200 may be operated without a water feed to either the water injector 160 or to the steam generator 162. Thus, during the start-up operating mode of the fuel cell system 200, external water is provided from the water source 164 into the fuel cell system 200 (e.g., into the water injector 160 or into the steam generator 162) to humidify the fuel. During the steady-state operating mode of the fuel cell system 200, provision of external water into the fuel cell system 200 may be stopped, and the water containing anode exhaust output from the stack 50 is recycled to humidify the fuel.

The fuel cell system 200 receives a fuel inlet stream from a fuel source 150 through a fuel supply conduit 340 (e.g., a fuel supply pipe or manifold). The fuel source 150 may be a fuel tank or gas line and may include a valve to control an amount of fuel provided. The fuel source 150 may include a hydrocarbon fuel, such as natural gas, methane, etc., or a hydrocarbon free fuel, such as hydrogen (H₂) or ammonia.

In particular, the fuel may be provided from the fuel supply conduit 340 to the CPOx reactor 170 (if present). Fuel output from the CPOx reactor 170 may be supplied to the mixer 180, the anode recuperator 110, and the stack 50 by a fuel supply line including fuel conduits 302A, 302B, 302C. In particular, fuel output from the CPOx reactor 170 may be supplied to the mixer 180 by fuel conduit 302A. Fuel (e.g., the fuel inlet stream) flows from the mixer 180 to the anode recuperator 110 through fuel conduit 302B. The fuel is heated in the anode recuperator 110 by anode exhaust (e.g., fuel exhaust) output from the stack 50, and the fuel then flows from the anode recuperator 110 to a fuel inlet of the stack 50 through fuel conduit 302C.

Air (e.g., air inlet stream) output from the main air blower 142 may be provided to the anode exhaust cooler 140, the cathode recuperator 120, and the stack 50 by an air supply line including air conduits 306A, 306B, 306C. In particular, air may be supplied from the main air blower 142 to the anode exhaust cooler 140 through air conduit 306A. Air flows from the anode exhaust cooler 140 to the cathode recuperator 120 through air conduit 306B. The air is heated by the ATO exhaust in the cathode recuperator 120. The air flows from the cathode recuperator 120 to the stack 50 through air conduit 306C.

An anode exhaust stream (e.g., fuel exhaust stream) output from the stack 50 is provided to the anode recuperator 110, the splitter 158, the vortex generator 159, the water injector 160, the anode exhaust cooler 140, and the mixer 180 by an anode exhaust line including anode exhaust conduits 308A, 308B, 308C, 308D, 308E. In particular, the anode exhaust output from an anode exhaust outlet of the stack 50 may be provided to the anode recuperator 110 through anode exhaust conduit 308A. The anode exhaust may contain unreacted fuel and may also be referred to herein as fuel exhaust. The anode exhaust may be provided from the anode recuperator 110 to the splitter 158 by anode exhaust conduit 308B. A first portion of the anode exhaust may be provided from the splitter 158 to the anode exhaust cooler 140 through the water injector 160 and the anode exhaust conduit 308C. A second portion of the anode exhaust is provided from the splitter 158 to the ATO 130 through the anode exhaust conduit 308D. The first portion of the anode exhaust heats the air inlet stream in the anode exhaust cooler 140 and may then be provided from the anode exhaust cooler 140 to the mixer 180 through the anode exhaust conduit 308E. The anode recycle blower 212 may be configured to move anode exhaust though anode exhaust conduit 308E.

Cathode exhaust generated in the stack 50 is provided to the ATO 130, the vortex generator 159, the cathode recuperator 120, and exhausted from the hotbox 102 by a cathode exhaust line including cathode exhaust conduits 304A, 304B, 304C. In particular, exhaust flows from the stack 50 to the ATO 130 through cathode exhaust conduit 304A. The vortex generator 159 may be located in cathode exhaust conduit 304A and may be configured to swirl the cathode exhaust. The anode exhaust conduit 308D may be fluidly connected to the vortex generator 159 or to the cathode exhaust conduit 304A or the ATO 130 downstream of the vortex generator 159. The swirled cathode exhaust may mix with the second portion of the anode exhaust provided by the splitter 158 before being provided to the ATO 130. The anode exhaust may be oxidized by the cathode exhaust in the ATO 130 to generate an ATO exhaust. The ATO exhaust flows from the ATO 130 to the cathode recuperator 120 through cathode exhaust conduit 304B. The ATO exhaust flows from the cathode recuperator 120 and out of the hotbox 102 through cathode exhaust conduit 304C.

Water is provided from a water source 164, such as a water tank or a water pipe, to the water injector 160. The water injector 160 injects water directly into a first portion of the anode exhaust provided in anode exhaust conduit 308C. Heat from the first portion of the anode exhaust (also referred to as a recycled anode exhaust stream) provided in anode exhaust conduit 308C vaporizes the water to generate steam. The steam mixes with the anode exhaust, and the resultant mixture is provided to the anode exhaust cooler 140. The mixture is then provided from the anode exhaust cooler 140 to the mixer 180 through the anode exhaust conduit 308E. The mixer 180 is configured to mix the steam and first portion of the anode exhaust with fresh fuel (i.e., fuel inlet stream). This humidified fuel mixture may then be heated in the anode recuperator 110 by the anode exhaust, before being provided to the stack 50.

The fuel cell system 200 may optionally include one or more fuel catalyst(s) which reform the humidified fuel mixture before it is provided to the stack 50. For example, an oxidation catalyst 112, a hydrogenation catalyst 114 and/or a steam methane reformation (SMR) catalyst 116 may be located inside of the anode recuperator 110. In some embodiments, the catalysts 112, 114, 116 may be in the form of catalyst “pucks” (e.g., cylinders) located inside a fuel inlet chamber 110F of the anode recuperator 110. The fuel (e.g., hydrocarbon fuel inlet stream) flows from the mixer 180 to the stacks 50 around and/or through the one or more catalysts 112, 114, 116 located in fuel inlet chamber 110F. However, in other embodiments, the catalysts 112, 114, 116 may be located downstream or upstream of the anode recuperator 110, with respect to an anode exhaust flow direction.

The fuel cell system 200 may further a system controller 225 configured to control various elements of the fuel cell system 200. The controller 225 may include a central processing unit configured to execute stored instructions. For example, the controller 225 may be configured to control fuel and/or air flow through the fuel cell system 200, according to fuel composition data, operating current, and/or operating temperature at any point in the fuel cell system 200.

FIGS. 3A and 3B are side cross-sectional views showing flow distribution through a central column 40 of the fuel cell system 200 of FIG. 2. FIG. 3A shows the fuel flow through the central column 40, while FIG. 3B shows the anode exhaust flow though the central column 40. FIG. 3C is a perspective view of an anode distribution structure 60. The central column 40 is located on and fluidly connected to the anode distribution structure 60.

Referring to FIGS. 2 and 3A-3C, the fuel cell stacks 50 (and/or fuel cell columns) may be located around the central column 40 in the hotbox 102. For example, the stacks 50 may be located in a ring configuration around the central column 40. The central column 40 may include the anode recuperator 110, the ATO 130, and the anode exhaust cooler 140. In particular, the anode recuperator 110 is located radially inward of the ATO 130, and the anode exhaust cooler 140 is located over the anode recuperator 110 and the ATO 130. Although not shown in FIGS. 3A and 3B, the cathode recuperator 120 may be located circumferentially around the stacks 50 such that the cathode recuperator 120 is close to the edges of the stacks 50 that are furthest from the central column 40.

The anode distribution structure 60 may be positioned under the anode recuperator 110 and ATO 130. The vortex generator 159 and the splitter 158 may be located over the anode recuperator 110 and ATO 130 and below the anode exhaust cooler 140.

The anode distribution structure 60 is used to distribute fuel evenly between the central column 40 and fuel cell stacks 50 located around the central column 40. The anode distribution structure 60 includes a central hub 62 and fuel conduits 302C and anode exhaust conduits 308A fluidly connected thereto. Each pair of conduits 302C, 308A connects to a respective fuel cell stack 50 (or fuel cell column as the case may be). The central hub 62 may be fluidly connected to the central column 40 (e.g., to the anode recuperator 110 located at the bottom of the central column 40). Although central hub 62 is illustrated as having fuel supplied to a lower level (before entering the fuel conduits 302C) and anode exhaust supplied to an upper level of the central hub 62 from the anode exhaust conduits 308A, those skilled in the art will recognize that the central hub can be configured to have fuel and anode exhaust supplied to the same level by utilizing a circular baffle to separate the two flows and extending the fuel conduits 302C through the circular baffle.

As illustrated in FIG. 3A, fuel from fuel conduit 302B enters the top of the central column 40. The fuel then flows through the anode recuperator 110 (e.g., the fuel inlet chamber 110F of the anode recuperator 110) to the central hub 62. The fuel then flows through the central hub 62 and fuel conduits 302C of the anode distribution structure 60 to the stacks 50.

As illustrated in FIG. 3B, the anode exhaust flows from the stacks 50 through conduits 308A into the central hub 62, and from the central hub 62 through the anode recuperator 110. In other words, the anode exhaust flows through an anode exhaust chamber 110A of the anode recuperator 110 where it heats the fuel flowing through the fuel inlet chamber of the anode recuperator 110. The anode exhaust then flows through conduit 308B into the optional splitter 158. A first portion of the anode exhaust can flow from the optional splitter 158 to the anode exhaust cooler 140 through conduit 308C, while a second portion optionally can flow from the splitter 158 to the ATO 130 through conduit 308D.

Air flows from the air conduit 306A to the anode exhaust cooler 140 (where it is heated by the first portion of the anode exhaust) and then flows from the anode exhaust cooler 140 through conduit 306B to the cathode recuperator 120. The first portion of the anode exhaust is cooled in the anode exhaust cooler 140 by the air flowing through the anode exhaust cooler 140. The cooled first portion of the anode exhaust is then provided from the anode exhaust cooler 140 to the anode recycle blower 212, as shown in FIG. 2.

The relative amounts of anode exhaust provided to the ATO 130 and the anode exhaust cooler 140 are controlled by the anode recycle blower 212. The higher the blower 212 speed, the larger portion of the anode exhaust is provided to conduit 308C, and a smaller portion of the anode exhaust is provided to the ATO 130 via conduit 308D, and vice-versa.

Silicon species, such as silicon, silica and/or siloxanes, may negatively impact the operation of the fuel cell system. In particular, the silicon species may deactivate fuel catalysts, and in particular the fuel reformation catalyst 116 which includes nickel. Silicon species may also form a residue within fuel cell stacks (e.g., on surfaces of the fuel cells). Although not conclusive, it is believed that the silicon species may be released from silica-based glass or glass ceramic seals that seal the fuel cell stacks during operation of the fuel cell system. The released silicon species can be mixed into the anode exhaust of the stack and are then recycled by the recycle blower 212 into the anode recuperator 110 containing the fuel reformation catalyst 116. Some fuels, such as biogas, may also contain silicon species, which can negatively impact the fuel reformation catalyst 116. In addition, sulfur species may slip through a desulfurization subsystem located in or downstream of the fuel source 150 and may damage the fuel catalysts.

Referring to FIGS. 2 to 3C, the fuel cell system 200 may include components configured to protect against system degradation due to silicon species and/or sulfur species. For example, the fuel cell system 200 may include one or more silicon species trapping components 210 (e.g., 210A, 210B, 210C, 210D and/or 210E) configured to sequester silicon species and/or other contaminants, such as sulfur species, from the anode exhaust stream and/or from the fuel.

The trapping component 210 may be in the form of a coating or a porous body (e.g., a silicon species trap) configured to sequester the silicon species via adsorption and/or absorption. For example, the trapping component 210 may be a coating (e.g., silicon species adsorbent material coating) that may be formed on the walls of conduits or other fuel cell system components. Alternatively, the trapping component 210 may be porous body which may comprise a monolith (e.g., a body with channels) of the trapping component 210 material (e.g., silicon species adsorbent material) or a ceramic monolith having surfaces (e.g., channel or pore surfaces) coated with the trapping component 210 material (e.g., silicon species adsorbent material). Alternatively, the porous body may comprise a sponge, foam or fiber material, such as nickel or ceramic sponge or foam, ceramic fibers, glass wool, etc. The trapping component 210 may comprise any suitable silicon species adsorbing and/or absorbing material (i.e., silicon species sequestering material), such as activated carbon, graphite, molecular sieve carbon, silica gel, nickel (e.g., nickel foam), alumina (e.g., unactivated or activated alumina), zeolite, or combinations thereof.

In one embodiment shown in FIGS. 2, 3B and 3C, the trapping component 210A may be located in each of the anode exhaust conduits 308A. For example, the trapping component 210A may be a porous body that is inserted into each of the anode exhaust conduits 308A or may be a coating coated inside (e.g., on the inner sidewalls of) each of the anode exhaust conduits 308A. In another embodiment shown in FIGS. 2, 3B and 3C, the trapping component 210B may be located in the hub 62 or coated on the inner surface of the hub 62 in addition to or instead of the trapping component 210A located in the anode exhaust conduits 308A.

In other embodiments shown in FIGS. 2, 3B and 3C, one or more trapping components 210C, 210D may be alternatively or additionally located inside of the anode recuperator 110. In one embodiment, the trapping component 210C is located in the anode exhaust chamber 110A of the anode recuperator 110 through which the anode exhaust flows from the stack 50 to the splitter 158. In another embodiment, the trapping component 210D is located in fuel inlet chamber 110F of the anode recuperator 110. For example, the trapping component 210D may comprise a porous body (e.g., a puck shaped body) located upstream of (e.g., above) the catalysts 112, 114 and 116 with respect to the fuel flow direction. Alternatively, the trapping component 210D may comprise a coating (e.g., a silicon species adsorbent layer) coated on a surface of the one or more catalysts (e.g., catalyst pucks) 112, 114 and/or 116. The use of an adsorbent coating, as compared to an adsorbent body, may provide a lower pressure drop and/or may simplify manufacturing. In yet another embodiment, both trapping components 210C, 210D are present, such that the trapping component 210C is located in the anode exhaust chamber 110A of the anode recuperator 110, and the trapping component 210D is located in fuel inlet chamber 110F of the anode recuperator 110.

In another embodiment shown in FIG. 2, an trapping component 210E is located in anode exhaust conduit 308E. In particular, the trapping component 210E may be located outside of the hotbox 102, which may reduce fuel cell system downtime when replacing the trapping component 210E. Thus, the trapping component 210E is located downstream of the anode recuperator 110 and upstream of the recycle blower 212 in the anode exhaust conduit 308E that fluidly connects an anode exhaust outlet of the anode exhaust cooler 140 to the recycle blower 212. In addition, the trapping component 210E may also be configured to capture carbon containing species, such as coke produced within the fuel cell system 200, which may be detrimental to the recycle blower 212 and/or other components of the fuel cell system 200.

In an alternative embodiment, one or more of the catalysts 112, 114, 116, such as the SMR catalyst 116, may include a silicon species tolerant catalyst material. The silicon species tolerant material functions as a catalyst, such as the SMR catalyst 116, and is not significantly degraded by the silicon species (e.g., has a less than 20% catalytic activity degradation, such as 0 to 10% degradation, after one year of operation).

The present inventors have determined that alkaline earth metal oxides may beneficially exhibit high basicity and high thermal stability, which makes such materials suitable candidates for use as promoters for Ni-based catalysts. The high basicity of alkaline earth metal oxides may also enhance H₂O adsorption, which may result in reduction of carbon deposition (e.g., coke formation) on the catalyst.

In particular, magnesium oxide (MgO) is a preferred catalyst support or promoter for a metal catalyst, such as a Ni-based reformation catalyst. MgO has a high catalytic activity, as compared to other metal oxides. MgO may also reduce Ni agglomeration during sintering of a Ni-based reformation catalyst and may prevent and/or reduce sulfur poisoning of nickel.

In addition, MgO in combination with Al₂O₃ typically forms the MgAl₂O₄ spinel material which also may inhibit coke formation. A combination of MgO and SiO₂ may provide a suitable support for nickel-based catalyst, which may lead to high catalyst activity and stability in the reforming process. These materials show high resistance to H₂S in gaseous feeds, showing no apparent impact on reformation.

According to various embodiments, the SMR catalyst 116 may comprise an alkaline earth metal oxide or metal silicate containing nickel catalyst material. For example, the SMR catalyst 116 may include nickel and a metal oxide, such as MgO, MgO/SiO₂, Al₂O₃, MgAl₂O₄ or combination thereof.

In one embodiment, the SMR catalyst comprises a magnesium nickel silicate (MNS) catalyst. In one embodiment, the MNS catalyst may have an orthorhombic magnesium silicate (e.g., Mg₂SiO₄) crystal lattice structure with nickel atoms located on the surface thereof and/or embedded interstitially and/or substitutionally in the Mg₂SiO₄ crystal lattice structure. In another embodiment, the MNS catalyst may additionally include aluminum. In another embodiment, the MNS catalyst may also include a noble metal catalyst, such as rhodium and/or platinum, in addition to nickel, in order to increase the catalyst stability and/or performance.

The SMR catalyst 116 may include a MNS porous body (e.g., a monolith, such as a porous puck), a MNS coating on the SMR catalyst puck (e.g., on a nickel and/or rhodium containing puck), a MNS coating on another support, such as a ceramic monolith or puck, and/or a MNS coating on sidewalls of the fuel inlet chamber 110F of the anode recuperator 110. The MNS catalyst is configured to sequester (e.g., adsorb) silicon species and/or sulfur species, while retaining high catalytic efficiency and low degradation over time.

In some embodiments, any one or more of the trapping components 210A, 210B, 210C, 210D and/or 210E may be used in combination with the SMR catalyst 116 which contains at least one metal oxide, such as the SMR catalyst 116 which contains the MNS material.

The fuel cell fuel cell systems of various embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A fuel cell system, comprising:
a stack of fuel cells;
a fuel supply line configured to provide a fuel to the stack;
an anode exhaust line configured to receive an anode exhaust from the stack; and
a trapping component configured to sequester silicon species included in the anode exhaust.

2. The fuel cell system of claim 1, wherein the trapping component comprises a porous body or a coating material which is configured to sequester the silicon species by at least one of adsorption or absorption.

3. The fuel cell system of claim 2, wherein:
the fuel cells comprise solid oxide fuel cells;
the stack further comprises silicon containing seals;
the trapping component comprises activated carbon, graphite, molecular sieve carbon, silica gel, nickel, unactivated alumina, activated alumina, zeolite, or a combination thereof; and
the silicon species comprise silicon, silica, siloxane, or a combination thereof.

4. The fuel cell system of claim 1, further comprising an anode recuperator which comprises a fuel inlet chamber containing a fuel catalyst, and an anode exhaust chamber, wherein the anode recuperator is configured to heat the fuel using the anode exhaust.

5. The fuel cell system of claim 4, wherein:
the anode exhaust line comprises a first exhaust conduit that fluidly connects an anode exhaust outlet of the stack to an anode exhaust inlet of the anode recuperator; and
the trapping component is located in the first anode exhaust conduit.

6. The fuel cell system of claim 4, wherein the trapping component is located in the fuel inlet chamber of the anode recuperator.

7. The fuel cell system of claim 6, wherein the trapping component is located upstream of the fuel catalyst with respect to a flow direction of the fuel, or the trapping component comprises a coating located on the fuel catalyst.

8. The fuel cell system of claim 5, wherein the trapping component is located in the anode exhaust chamber of the anode recuperator.

9. The fuel cell system of claim 4, wherein the fuel catalyst comprises a manganese nickel silicate steam methane reformation catalyst.

10. The fuel cell system of claim 4, wherein:
the trapping component comprises multiple trapping components; and
the multiple trapping components comprise at least two of:
a first trapping component located in a first anode exhaust conduit that fluidly connects an anode exhaust outlet of the stack to an anode exhaust inlet of the anode recuperator;
a second trapping component located in the fuel inlet chamber of the anode recuperator;
a third trapping component located in the anode exhaust chamber of the anode recuperator; and
a fourth trapping component located in a second anode exhaust conduit that fluidly connects an anode exhaust outlet of an anode exhaust cooler heat exchanger to a recycle blower.

11. The fuel cell system of claim 1, further comprising:
an anode exhaust cooler heat exchanger configured to receive the anode exhaust from the anode recuperator and to cool the anode exhaust using air provided to the stack;
a recycle blower located on the anode exhaust line;
a mixer fluidly connecting the anode exhaust line to the fuel supply line; and
a hotbox housing the stack, the anode recuperator, and the anode exhaust cooler heat exchanger,
wherein:
the anode exhaust line comprises a second exhaust conduit that fluidly connects an anode exhaust outlet of the anode exhaust cooler heat exchanger to the recycle blower; and
the trapping component is located outside of the hotbox in the second anode exhaust conduit.

12. A method of operating a fuel cell system, comprising:
providing a fuel to a stack of fuel cells;
providing an anode exhaust containing a silicon species from the stack; and
sequestering the silicon species at a trapping component.

13. The method of claim 12, wherein:
the trapping component comprises a porous body or a coating material which sequesters the silicon species by at least one of adsorption or absorption;
the fuel cells comprise solid oxide fuel cells;
the trapping component comprises activated carbon, graphite, molecular sieve carbon, silica gel, nickel, unactivated alumina, activated alumina, zeolite, or a combination thereof; and
the silicon species comprises silicon, silica or siloxane.

14. The method of claim 12, further comprising:
an anode recuperator that heats the fuel using the anode exhaust; and
an exhaust conduit that fluidly connects an anode exhaust outlet of the stack to an anode exhaust inlet of the anode recuperator.

15. The method of claim 14, wherein the trapping component is located in the anode exhaust conduit.

16. The method of claim 14, wherein the trapping component is located inside of the anode recuperator.

17. The method of claim 14, further comprising recycling the anode exhaust into the fuel using a recycle blower, wherein the trapping component is located downstream of the anode recuperator and upstream of the recycle blower.

18. A fuel cell system, comprising:
a stack of fuel cells;
an anode recuperator configured to heat a fuel provided to the stack using an anode exhaust output from the stack; and
a reformation catalyst located in the anode recuperator, the reformation catalyst comprising nickel and a metal oxide.

19. The fuel cell system of claim 18, wherein the reformation catalyst comprises magnesium nickel silicate.

20. The fuel cell system of claim 19, wherein the reformation catalyst further comprises at least one of rhodium or platinum.

21. The fuel cell system of claim 19, wherein the magnesium nickel silicate comprises an orthorhombic magnesium silicate crystal lattice and nickel atoms located thereon or therein.
